(19) United States
(12) Patent Application Publication
(10) Pub. No.: US 2025/0042094 A1
(43) Pub. Date: Feb. 6, 2025

(54) APPARATUS FOR ATTACHING A BUILDING MATERIAL TO A BASE

(71) Applicant: VF-Yhtiöt Oy, Tuusula (FI)

(72) Inventor: Ville Fingerroos, Tuusula (FI)

(21) Appl. No.: 18/717,074

(22) PCT Filed: Dec. 8, 2022
(86) PCT No.: PCT/FI2022/050817

§ 371 Date: Jun. 6, 2024

(30) Foreign Application Priority Data
Dec. 10, 2021 (FI) 20216266

(51) Int. Cl. B29C 65/14; B29L 31/10; E04D 15/04

(52) U.S. Cl. CPC B29C 65/1412; B29C 65/1432; B29C 65/1458; E04D 15/04; B29L 2031/108; E04D 2015/042

(57) ABSTRACT

The presented solution describes an apparatus for attaching a building material to a base, the apparatus comprising at least one infrared heater for producing heat to a surface of the building material and a motor for moving the apparatus. In the apparatus, the building material, once straightened out onto the base, is adapted to be fed in from a first end of the apparatus and to be discharged from a second end of the apparatus while being attached to the base. A method of attaching a building material to a base by means of the apparatus is also described.

### CROSS-REFERENCE TO RELATED APPLICATIONS

This application is a national stage entry of International Patent Application No. PCT/FI2022/050817 (filed 8 Dec. 2022), which claims priority to Finnish Patent Application No. 20216266 (filed 10 Dec. 2021).

### BACKGROUND OF THE INVENTION

Generally, various exemplary embodiments relate to an apparatus for attaching a building material to a base. Some exemplary embodiments relate, at least partly, to an apparatus equipped with an infrared heater.

A building material, such as rolled roofing, is usually attached to a base manually by means of a blowtorch flame. As the installation of the building material involves many fire and security risks, it is subject to further development.

### SUMMARY OF THE INVENTION

The inventions aim at providing a novel apparatus for attaching a building material to a base, as well as a related method characterized in what is set forth in the independent claims. The dependent claims relate to some preferred embodiments of the invention.

The exemplary embodiments of the presented solution provide a novel attachment method and an apparatus that allow a building material to be installed to a base in a faster, easier and safer way. The apparatus also allows the installation to be performed in a more ergonomic working position. The end result is uniform, and the method is an environmentally friendly and cost-effective.

A first solution may comprise an apparatus for attaching a building material to a base, wherein the apparatus may comprise at least one infrared heater for producing heat to a surface of the building material; and at least one motor for moving the apparatus; wherein, in the apparatus, the building material, once straightened out onto the base, is adapted to be fed in from a first end of the apparatus; to be heated by the infrared heater; and to be discharged from a second end of the apparatus while being attached to the base.

According to an exemplary embodiment of the first solution, the apparatus may comprise at least three rollers adapted to guide the travel of the building material.

According to an exemplary embodiment of the first solution, at least one of the three rollers may comprise a pressing roller adapted to fixedly press the building material against the base.

According to an exemplary embodiment of the first solution, the motor may be a roller motor.

According to an exemplary embodiment of the first solution, the infrared heater may be adapted to direct the heat perpendicularly to the lower surface of the building material.

According to an exemplary embodiment of the first solution, the apparatus may comprise a guiding table.

According to an exemplary embodiment of the first solution, the apparatus may comprise a control unit that may be adapted to adjust at least the speed of the apparatus and the temperature of the infrared heater.

According to an exemplary embodiment of the first solution, the apparatus may comprise at least one temperature sensor that may be adapted to measure the temperature of the building material.

According to an exemplary embodiment of the first solution, the control unit may be adapted to adjust the speed of the apparatus based on the temperature measured by the at least one temperature sensor.

According to an exemplary embodiment of the first solution, the control unit may be adapted to turn off the at least one infrared heater when the temperature measured by the at least one temperature sensor exceeds a threshold.

According to an exemplary embodiment of the first solution, the at least one infrared heater may be swiveling.

According to an exemplary embodiment of the first solution, the at least one infrared heater may be adapted to steplessly swivel for different positions and/or different temperatures.

According to an exemplary embodiment of the first solution, the infrared heater may comprise at least one lamp.

According to an exemplary embodiment of the first solution, the apparatus may also comprise at least one fan, or the apparatus may be adapted to be connected to a fan; and/or at least one extractor, or the apparatus may be adapted to be connected to an extractor.

A second solution may comprise a method of attaching a building material to a base by means of an apparatus, wherein the apparatus may comprise at least one infrared heater for producing heat to a surface of the building material; and a motor for moving the apparatus; wherein, in the method, a building material, once straightened out onto the base, may be fed in from a first end of the apparatus; heated by the infrared heater; and discharged from a second end of the apparatus while being attached to the base.

### DESCRIPTION OF THE FIGURES

In the following, the invention will be explained in more detail by means of preferred embodiments, by referring to the accompanying drawings where:

FIG. 1 a schematic view of an apparatus for attaching a building material according to an exemplary embodiment; and

FIG. 2 a schematic view of a method of attaching the building material by means of the apparatus according to an exemplary embodiment.

### DETAILED DESCRIPTION OF THE INVENTION

Various embodiments of the invention will appear from the following detailed description of the invention made by referring to the examples of the figures. However, the invention is not solely restricted to these examples, but the embodiments of the invention may vary within the scope of the claims.

According to an example, building materials may be attached to a base by manually welding with a blowtorch flame or by gluing with hot bitumen melted in a bitumen pot. The attachment method may be divided into three steps: unrolling or straightening in place, re-rolling and re-opening allowing attachment to the base by welding or gluing. As the welding with a blowtorch flame may involve a fire and safety risk, it may not be applicable to responsive bases or readily inflammable objects. Further, the welding may be unergonomic and hard for the installer, causing, among other things, musculoskeletal disorders. The hot bitumen may also cause dangerous situations if it is attached by gluing. The quality of the installation is completely dependent on how skilled and careful the installer is. Further, the installation work may involve several steps related to the unrolling, possibly slowing down the installation work.

According to an exemplary embodiment, the installation of the building material takes place in two steps by means of the apparatus intended for it: first, the roll is opened out or straightened in place, whereafter the apparatus directly laminates the product to the base by means of infrared radiation. In this installation, the necessary heating, i.e. the melting of the building material, may be carried out by using infrared technology. As the building material may be spread out onto the base before the installation, it does not have to be transported in a rolled-up stated together with the apparatus, but the product circulates through the apparatus and the apparatus presses the building material against the surface. This allows the apparatus to be smaller and lighter in weight, and it does not have to carry a heavy roll possibly weighing more than 40 kilos or more, for example. Any softness of the base does not restrict the movement of the apparatus either, allowing the apparatus to attach the building material to a soft base as well. Therefore, the size of the roll does not have to be restricted for weight reasons either. As an example, if the building material is installed on wool, the apparatus does not get pressed into the base. The infrared heater allows the building material to be attached over the entire wide of the product, and there is a small risk of fire compared to a blowtorch. Further, the apparatus allows a variety of materials, such as wood- and/or plastic-based insulations that may easily melt and/or catch fire, to be used as the mounting base. The method is also work-safe because it does not involve handling fire. The apparatus provides a high-quality installation by heating the building material uniformly, and, thus, glues it to the base evenly to prevent any leak spots. Further, the number of installation steps is reduced by just opening out the roll and straightening it on the mounting base, whereafter the apparatus directly attaches the product to the base by means of the infrared heater. This eliminates the installation work step of re-rolling the building material and spreading it for a second time, carried out in blowtorch flame welding or hot bitumen gluing.

An exemplary embodiment comprises an apparatus for attaching a building material to a base. The apparatus may comprise at least one infrared heater for producing heat to a surface of the building material and a motor for moving the apparatus. The building material, once straightened out onto the base, may be adapted to be fed in from a first end of the apparatus, to be heated by the infrared heater and to be discharged from a second end of the apparatus while being attached to the base.

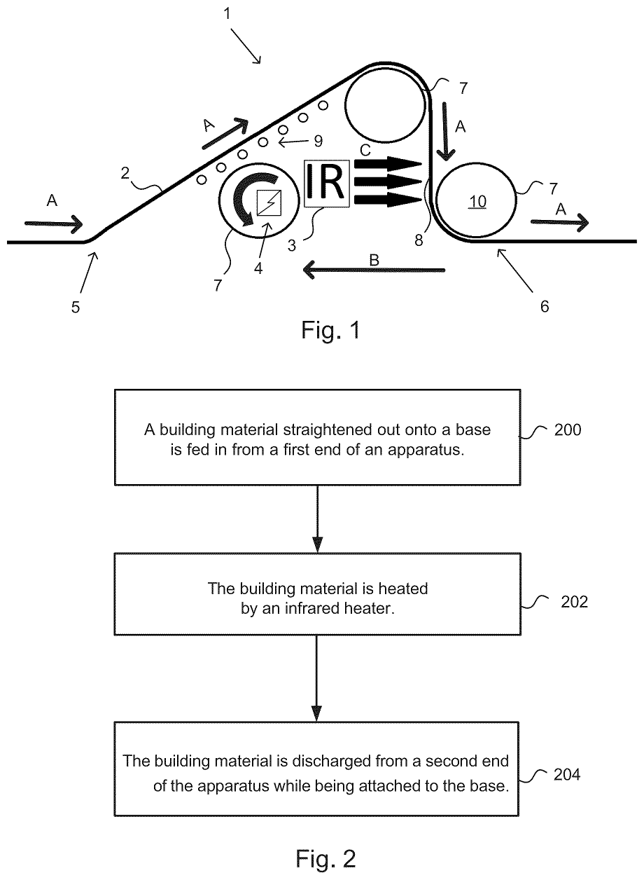

FIG. 1 is a schematic view of an apparatus 1 for attaching a building material 2 according to an exemplary embodiment. For clarity, the casing or covering of the apparatus 1 is omitted in FIG. 1.

According to an exemplary embodiment, the apparatus 1 may comprise at least one infrared heater 3 for producing heat to a surface of the building material and a motor for moving the apparatus 1. The building material 2, once straightened out onto the base, may be adapted to be fed in from a first end 5 of the apparatus 1, to be heated by the infrared heater 3 and to be discharged from a second end 6 of the apparatus while being attached to the base. Preferably, the first and second ends 5, 6 are located at opposite edges of the apparatus 1. In FIG. 1, the movement of the building material 2 through the apparatus 1 and the movement of the apparatus with respect to the mounting base are denoted by arrows A and an arrow B, respectively. The building material 2 may comprise at least one of the following: a waterproofing membrane, such as ethylene propylene diene monomer rubber (EPDM) or polyvinyl chloride (PVC), a thermoplastic material, a waterproofing material and/or a roofing material, such as modified (asphalt) roll roofing. The apparatus 1 may be adapted to substantially install the building material 2 on a horizontal surface, a vertical surface and/or a slanting surface.

According to an exemplary embodiment, the infrared heater 3 may comprise at least one lamp. The more lamps the infrared heater 3 comprises, the more power it is able to produce and the more the infrared heater 3 heats the lower surface 8 of the building material. The infrared heater 3 may also comprise a lamp locking system which may be a snap-lock coupling for fast coupling and uncoupling the lamp to and from the infrared heater 3. The lamp may comprise one or more bulbs, such as one to six bulbs. A protective visor may be connected in front of the lamp to prevent the lamp light from reaching the worker's eyes. The visor may be swiveling or fixed. The visor may be made of plastic or metal. The visor may be connected to a protective cover provided for the lamp 3 or to the frame of the apparatus 1 itself.

According to an exemplary embodiment, the infrared heater 3 may be adapted to perpendicularly direct the heat to the lower surface 8 of the building material, as shown by arrows C in FIG. 1. Compared to diagonal heating, the perpendicular heating from the infrared heater to the lower surface 8 of the building material contributes to the directing of the infrared heater's output to the lower surface 8 of the building material. The heating may cause the lower surface 8 of the building material to melt uniformly throughout, with the result that the attachment to the base and the installation quality are optimum.

According to an exemplary embodiment, the apparatus 1 may comprise one or more infrared heaters 3. According to an exemplary embodiment, the at least one infrared heater 3 may be swiveling. The infrared heater 3 may substantially be able to swivel towards the surface of the building material 2 or the mounting base. According to an exemplary embodiment, the infrared heater 3 may dry the base in one position and heat the building material 2 in another position. As an example, the infrared heater 3 may be used for drying the base prior to starting the installation. In this case, the infrared heater 3 may be turned down towards the base to allow the mounting base to be dried by the apparatus. After the drying, the infrared heater 3 may be turned to heat the lower surface 8 of the building material for the duration of the installation. According to an exemplary embodiment, the infrared heater 3 is steplessly swiveling for different positions and/or different temperatures, depending on the current use of the apparatus 1.

According to an exemplary embodiment, at least one infrared heater 3 may be adapted to heat the building material 2 and/or at least one infrared heater 3 may be adapted to dry the base. As an example, the apparatus 1 may comprise two infrared heaters 3, one of them may dry the mounting base while the other one of them may heat the lower surface 8 of the building material. This allows the mounting base and the building material 2 to be dried and installed, respectively, at the same, for example.

According to an exemplary embodiment, the apparatus 1 may comprises at least three rollers 7 adapted to guide the travel of the building material 2. The roller 7 may be adapted to rotate around a center axis of the roller 7. The roller 7 may be fastened to the frame of the apparatus 1 at its both ends. The rollers 7 allow the travel of the building material 2 to be guided inside the apparatus 1 and the attachment of the building material 2 to the base to be enhanced. As appears from the example shown in FIG. 1, the building material 2 enters from the first end 5 of the apparatus 1, as denoted by arrow A, and continues its travel, over first and second rollers 7, to a third roller 7 guiding the building material 2 to pass under the third roller 7 while pressing the lower surface of the building material 2 heated between the first and second rollers 7 against the base. As the installation continues, the apparatus moves in the direction denoted by arrow B, i.e. in the direction where the building material enters. Thus, the building material 2 moves, inside the apparatus, in a direction opposite to the travel direction of the apparatus 1.

According to an exemplary embodiment, at least one roller 7 may comprise a pressing roller 10 adapted to press the building material 2 against the base. The pressing roller 10 guides the building material 2 towards the base and presses it tightly against the base by a rotational movement. The pressing roller 10 may comprise a sliced pressuring roller. The sliced pressuring roller may comprise a number of discs. The sliced pressuring roller may also comprise at least one spring.

According to an exemplary embodiment, the at least one motor 4 may be a roller motor. At least one roller 7 may comprise a roller motor. The roller motor may be placed within the at least one roller 7. The roller motor may be adapted to rotate the roller 7 and to move the apparatus 1 forward. As appears from FIG. 1, the motor 4 rotates the roller 7 counterclockwise, with the result that the apparatus moves in a direction towards the first end 5, i.e. in the direction where the building material 2 enters the apparatus 1. As the motor 4 makes it unnecessary to push the apparatus 1, the installation work is easier. The surface material of the roller 7, roller motor and/or pressing roller 10 may be metal, for example, which may be coated by at least one of the following materials: rubber, polyurethane and/or Teflon. The coating material may prevent the roll roofing from attaching to the surface of the roller, the roller motor and/or the pressing roller. The apparatus 1 may also comprise a roller cleaner or a soot collector collecting any building material stuck to the roller 7. The roller cleaner may be automated.

According to an exemplary embodiment, the at least one motor 4 may be an electric motor. The electric motor may be more preferred over gas by making it unnecessary to carry gas bottles to the work site, such as up to a roof. Further, the use of electricity eliminates the risk of explosion. Usually, the gas is stored on the roof and used in abundance, thus increasing the costs and, in case of fire, possibly putting the rescue personnel at a significant safety disadvantage. The electric motor may be grid- or battery-powered. Electric power is generally available, and where it is not available, a re-chargeable battery may be used, or, for example, an aggregate may be utilized to produce electricity.

According to an exemplary embodiment, the apparatus 1 may comprise a guiding table 9. The guiding table 9 may help the building material 2 to travel straight inside the apparatus 1. The guiding table 9 may comprise a roller table. The roller table may make it easier for the building material 2 to travel inside the apparatus 1 since the building material 2 travels more smoothly on the roller table. FIG. 1 shows that the guiding table may be placed above the first roller, before the second roller 7. The roller table may comprise several guiding rollers on which the building material may roll forward easier. The first roller 7 may be adapted to rotate the guiding rollers of the roller table. The roller table 9 may be openable to make it easier to insert the building material 2 into the apparatus 1. Further, the guiding table 9 may comprise at least one lateral guide which is adjustable according to the width of the building material 2 being installed.

According to an exemplary embodiment, the apparatus 1 comprises a control unit adapted to adjust at least the speed of the apparatus 1 and/or the temperature of the infrared heater 3. The speed of the apparatus 1 and/or the temperature of the infrared heater 3 may be adjusted to a desired level according to the melting temperatures of different building materials 2, for example. The melting temperatures of the different building materials 2 vary from 150° C. to 250° C., for example. The control unit may be placed on the guiding table 9 or in proximity thereto, for example. The control unit may have a starter for manually starting the apparatus or the apparatus may be started by means of a remote switch, an identification card, a fingerprint, a PIN code and/or a remote control. The apparatus may also comprise an operating device, such as a handle. The operating device may also comprise a start-stop button.

According to an exemplary embodiment, the apparatus 1 may provide remote operability. The remote operability allows the temperature of the infrared lamp 3 or the speed of the apparatus 1 to be adjusted, for example. The remote operability may be adapted to be utilized by means of a mobile device, a computer or a tablet, for example. The remote operability may be implemented with an application. The control unit may also comprise a display. An application usable by means of the display may be downloaded into the control unit. The apparatus 1 and the control unit may be contacted over a wireless connection, such as a Bluetooth connection, WLAN or some other appropriate connection, by a mobile device.

According to an exemplary embodiment, the apparatus 1 may comprise at least one temperature sensor that may be adapted to measure the temperature of the building material 2. The temperature sensor may provide information on the correct installation temperature of the building material 2. The temperature may be measured at several spots, such as at the both edges or the center of the building material. At least one temperature sensor may be placed close to the melting surface of the building material in order to find out the current temperature of the building material.

According to an exemplary embodiment, at least one temperature sensor may be placed in proximity to the infrared heater 3, such as below it. The temperature sensor may measure the temperature of the lower surface 8 of the building material by means of at least one infrared beam, for example. If the temperature is measured at several spots, the temperature sensor may provide an average of the measuring results for the control unit. As the temperature sensor may measure the temperature by means of the infrared beam, it may be placed below the infrared heater 3, the temperature sensor thus measuring the temperature of the lower surface 8 of the building material, not the temperature of the infrared heater 3. The temperature may only be measured at the endpoints of the infrared beams, i.e. on the lower surface 8 of the building material 2. Therefore, a very accurate measuring result may be obtained.

According to an exemplary embodiment, the control unit may be adapted to adjust the speed of the apparatus 1 according to a temperature measured by at least one temperature sensor. The control unit may adjust the speed of the apparatus automatically according to the temperature measured by the temperature sensor. If the temperature of the apparatus 1 gets too high or too low, the apparatus 1 may be adjusted to travel at a higher speed, at a lower speed or automatically at the right speed. The temperature of the building material 2, the weather conditions and/or the outside temperature may cause the temperature of the building material 2 to rise. The apparatus 1 may install the building material on the base at a speed of 5 to 60 seconds per meter or preferably at a speed of 10 to 30 seconds per meter, for example. The installation speed depends on the building material, its properties and thickness.

According to an exemplary embodiment, the control unit may be adapted to turn off the at least one infrared heater 3 when the temperature measured by at least one temperature sensor exceeds a threshold. The threshold may be 250° C., for example. This may prevent the installed building material 2 from getting overheated which may cause damage to the product.

According to an exemplary embodiment, the apparatus 1 may also comprise at least one fan and/or extractor. Alternatively, the apparatus 1 may be adapted to be connected to a fan and/or an extractor. Thus, the fan and/or extractor may be separate devices and be located outside the apparatus 1. The extractor may be a smoke extractor capable of extracting any harmful substances, smokes and/or combustion gases created during the heating of the building material 2 out of the apparatus 1, thus increasing the work safety. The fan may be adapted to direct the substances, smokes and/or combustion gases created during the heating to the extractor. The extractor may also be placed behind the infrared heater 3 to direct the hot air from the infrared heater 3 to the lower surface 8 of the building material.

According to an exemplary embodiment, the lamp comprises a sheath structure for guiding the flow of the air so that the air does not escape to the sides of the lamp but is directly guided towards the surface of the building material 2. The fan may be adapted to blow the air into the sheath structure to be conducted therefrom, by the sheath structure, to the surface being heated.

According to an exemplary embodiment, the extraction pipe of the extractor may be connected to the frame structure. The frame structure may comprise at least one frame pipe to which the extraction pipe of the extractor may be connected. The extraction pipe of the extractor may be connected to the second end of the at least one frame pipe of the frame structure. The handling of the extractor connection may be changed, i.e. the extraction pipe of the extractor may be connected to the first end or the second end of the frame pipe or to a frame pipe that is open at the left or right edge of the apparatus 1. The apparatus 1 is able to coat areas near a wall. In this case, the extraction pipe of the extractor facing the wall may be disconnected and connected to a frame pipe at the other edge of the apparatus 1 in order to operate as close to the wall as possible. The frame pipe may be a transverse pipe. It may extend parallel to the infrared heater inside the apparatus 1. The frame pipe may be provided with holes through which the extractor may extract any harmful substances, smokes and/or combustion gases, which have formed during the heating of the building material 2, out of apparatus 1. These harmful substances, smoke and/or gases may also be extracted into the open end of the pipe.

According to an exemplary embodiment, the extractor has a filter, such as an electric filter. The electric filter may comprise an activated carbon filter, for example, capable of filtering the harmful gases and/or smokes and, at the same time, of preventing the formation of pitch in the motor or the accumulation of different substances, which have formed during the installation, on the surface of the motor.

According to an exemplary embodiment, the pressing roller 10 comprises a spring system, such as at least one cylinder. The pressing roller 10 may have a cylinder at its both ends. At least one cylinder may act as a shock absorber. At least one cylinder may allow the apparatus 1 to move on a slanting surface and the pressing roller 10 to flex on uneven terrain.

According to an exemplary embodiment, the apparatus 1 may be operated or moved by remote controlling or by moving it physically. In remote controlling, the roller motor moves the apparatus 1. In remote controlling, the apparatus may be controlled wirelessly. Further, the apparatus may be moved by physically pushing or pulling it, if necessary. The apparatus may also be moved physically while the roller motor partly assists to the movement to make the physical moving easier.

The apparatus 1 may be integrated with a factory production line. As an example, the apparatus 1 may be used in a factory where a building material is attached to a base. The factory may be a roofing factory, for example. The apparatus 1 may be lowered down from the ceiling or the apparatus 1 may move on rails.

According to an exemplary embodiment, the width of the apparatus is 1000 to 2000 mm. The length of the apparatus may be 800 mm, for example. The height of the apparatus 1 may be 150 to 250 mm, for example. The apparatus 1 is small in size compared to known apparatuses. Therefore, a building material may also be attached in cramped places.

According to an exemplary embodiment, the guiding table 9 and/or the infrared heater 3 are removable. This allows them to be replaced and easily maintained.

FIG. 2 is a schematic view of a method of attaching a building material 2 to a base by means of an apparatus 1, wherein the apparatus 1 may comprise at least one infrared heater 3 for producing heat to a surface of the building material 2 and a motor 4 for moving the apparatus 1.

At step 200 according to the method, the building material 2, once straightened out onto the base, may be fed into the apparatus from a first end 5 of the apparatus 1.

At step 202 according to the method, the building material 2 may be heated by the infrared heater 3.

At step 204 according to the method, the building material 2 may be discharged from a second end 6 of the apparatus 1 while being attached to the base.

Since the other features are directly derived, for example, from the functionalities and parameters of the apparatus 1, and of the systems therein, as is described in the appended claims and in the entire specification, they will not be repeated here. Different variations of the method are also applicable, as is described in the different embodiments, for example.

Any range or device value given herein may be extended or altered without losing the effect sought. Also any embodiment may be combined with another embodiment, unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to “an item” may refer to one or more of those items.

The steps or operations of the methods described herein may be carried out in any suitable order, or simultaneously where appropriate. Additionally, individual steps may be deleted from any of the methods without departing from the spirit and scope of the subject matter described herein. Aspects of any of the examples described above may be combines with aspects of any of the other examples described to form further examples without losing the effect sought.

It is obvious to a person skilled in the art that as technology advantages, the basic idea of the invention may be implemented in a variety of ways. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit and scope of this specification. Consequently, the invention and its embodiments are not restricted to the above examples but may vary within the scope of the claims.

1. An apparatus for attaching a building material to a base, the apparatus comprising:
at least one infrared heater for producing heat to a surface of the building material; and
at least one motor for moving the apparatus, wherein, in the apparatus, the building material, once straightened out onto the base, is adapted to be:
fed in from a first end of the apparatus;
heated by the infrared heater; and
discharged from a second end of the apparatus while being attached to the base.

2. The apparatus of claim 1, the apparatus comprising at least three rollers adapted to guide travel of the building material.

3. The apparatus of in claim 2, wherein at least one of three rollers comprises a pressing roller adapted to press the building material against the base.

4. The apparatus of claim 1, wherein the motor is a roller motor.

5. The apparatus of claim 1, further comprising a guiding table.

6. The apparatus of claim 1, further comprising a control unit adapted to adjust at least one of a speed of the apparatus or a temperature of the infrared heater.

7. The apparatus of claim 6, further comprising at least one temperature sensor adapted to measure a temperature of the building material.

8. The apparatus of claim 7, wherein the control unit is adapted to adjust the speed of the apparatus based on the temperature measured by the at least one temperature sensor.

9. The apparatus of claim 7, wherein the control unit is adapted to turn off the at least one infrared heater when the temperature measured by the at least one temperature sensor exceeds a threshold.

10. The apparatus of claim 1, wherein the infrared heater is adapted to direct the heat perpendicularly to the lower surface of the building material.

11. The apparatus of claim 1, wherein the at least one infrared heater is configured to swivel.

12. The apparatus of claim 1, wherein the at least one infrared heater is adapted to steplessly swivel for one or more of different positions or different temperatures.

13. The apparatus of claim 1, wherein the infrared heater comprises at least one lamp.

14. The apparatus of claim 1, further comprising one or more of:
at least one fan or the apparatus is adapted to be connected to a fan; or
at least one extractor or the apparatus is adapted to be connected to an extractor.

15. A method of attaching a building material to a base by means of an apparatus, the apparatus comprising:
at least one infrared heater for producing heat to a surface of the building material; and
a motor for moving the apparatus, wherein, in the method, the building material, once straightened out onto the base, is:
fed in from a first end of the apparatus;
heated by the infrared heater; and
discharged from a second end of the apparatus while being attached to the base.
